(19) United States
(12) Patent Application Publication
(10) Pub. No.: US 2006/0151488 A1
(43) Pub. Date: Jul. 13, 2006

(54) Apparatus for providing food service

(75) Inventors: Katherine J. Ruffing, Evanston, IL (US); Julie A. Pedretti, Middleton, WI (US); Douglas A. Redmond, Middleton, WI (US); Suzy X. Zeng, Northfield, IL (US)

Correspondence Address: FITCH EVEN TABIN & FLANNERY, 120 S. LASALLE STREET, SUITE 1600, CHICAGO, IL, 60603-3406, US

(73) Assignee: Kraft Foods Holdings, Inc., Northfield, IL (US)

(21) Appl. No.: 11/178,358

(22) Filed: Jul. 12, 2005

Related U.S. Application Data
(63) Continuation-in-part of application No. 11/030,080, filed on Jan. 7, 2005.

(51) Int. Cl. H05B 6/80

(52) U.S. Cl. 219/725

(57) ABSTRACT

A food service apparatus is provided as a combination providing everything needed for food storage, advertising, preparation, and service.

### CROSS-REFERENCE TO RELATED APPLICATIONS

This application is a continuation-in-part of prior application Ser. No. 11/030,080, filed Jan. 7, 2005, which is incorporated herein by reference in its entirety.

### FIELD OF THE INVENTION

This invention relates generally to an apparatus and method for providing food service, and more particularly to an apparatus and method for providing walk-up self-service of frozen or refrigerated convenience foods.

### BACKGROUND OF THE INVENTION

There is significant consumer demand for packaged single serving food items which can be selected and prepared on-site by patrons themselves of retail stores. The patrons can then consume the cooked food items on-site or “on-the-go” either in a hand held manner, or with serving plates/bowls and eating utensils, whichever is convenient or desired. Retail stores have marketed food products which require a minimum amount of consumer preparation, and also have provided walk-up food preparation capabilities in which frozen foods are sold, cooked on-site, and then eaten on-site or off-site by patrons. For instance, preassembled frozen sandwiches, pizzas, burritos, etc., have been sold from freezers at retail locations which can be cooked or warmed up by customers on-site using a rapid heating oven, such as a microwave oven, provided at the same location. Freezing the sandwiches increases the product's shelf life and helps preserve the freshness of the product until defrosted and cooked. Heating the sandwiches not only defrosts the food items but also makes them more chewable and savory for the patron.

Convenience stores and other retail venues often have limited floor space available to install on-site frozen food storage and cooking equipment. Patrons commonly are provided a relatively limited area in the stores in which to prepare their frozen food selection and purchase for consumption. If greater food preparation areas are provided, it may come at the expense of product shelving or advertising display space available within the store. Also, patrons carrying out self-service cooking operations at convenience stores and the like often are pressed for time, and may not be very familiar with the provided cooking equipment and/or a selected food product. The cooking equipment generally will be used by many different patrons having varying levels of dexterity and familiarity with the particular cooking equipment provided at that location.

### SUMMARY OF THE INVENTION

The invention provides an apparatus for self-service of foods. The apparatus is a combination providing everything needed for food storage, advertising, preparation, and service.

In one embodiment, a food service apparatus is provided having a food storage unit and a cabinet module housing an oven on its upper side and at last one lateral side. The food storage unit and cabinet module are arranged side-by-side. A food-advertising display module includes a substantially upright portion and a substantially horizontal portion upon which a lower portion of the food storage unit and a bottom portion of the oven rest, effective to stabilize the display module against tilting or tipping. The combination provided is adapted to be supported on a separate relatively larger support surface, such as an upraised kitchen-type countertop surface.

In a particular embodiment, the food-advertising display module comprises signage attached to upright portion thereof. The signage may include graphics identifying at least one food item contained in the food storage unit.

In another particular embodiment, the food storage unit includes an access door having a transparent portion adapted to allow food items stored within the food storage unit to be viewed from outside the food storage unit. The food storage unit may be a freezer or a refrigeration unit.

In another particular embodiment, the oven may be a microwave oven, convection oven, a hybrid oven combining microwave and convection heating means, a toaster, and so forth. The oven may comprise an electronic menu including at least one button pre-programmed to activate the oven to heat a corresponding food item from the storage unit for a predetermined set of heating conditions for that food item. More particularly, the oven may comprises a programmable cooking controller and a plurality of push control buttons associated with identifying means for a plurality of different types of food items stored in the food storage unit. The buttons are manually activatable to activate the controller to operate the oven to heat a selected type of frozen food item under predetermined cooking conditions corresponding to the selected type of frozen food item. The oven, and the food storage unit, may further comprise an electrical power outlet adapted for connection of electrical power transmission means thereto.

In another particular embodiment, the cabinet module further defines an additional enclosure space adapted to receive and store at least one food service item selected from the group consisting of napkins, trays, eating utensils, and food condiments.

In another embodiment, a food service apparatus is provided without the built-in trash module and receptacle, wherein a food storage unit and a cabinet module housing an oven and supporting a food-advertising module are fixedly positioned in a side-by-side configuration on a countertop means. The countertop means may be a transportable discrete slab member that is supportable on a separate relatively larger support surface, or alternatively it may be a countertop that is fixed in position.

In another embodiment, there is a method for providing food service, comprising (A) locating, at a desired food retail location, an apparatus such as exemplified herein, and (B) placing a plurality of food items in the food storage unit of the apparatus which are available for rapid preparation by patrons in the oven component of the apparatus.

The self-service food apparatus of embodiments of the present invention may be used in convenience retail stores and other venues suited for walk-up and walk-away food service by patrons and users of the self-service units. In another embodiment, different kinds and/or shapes of food products can be cooked with the same apparatus.

The food items that can be merchandised with the apparatus are not particularly limited. In a particular embodiment, they are portable packaged food products including, for example, sandwiches, food wraps, pocket-type foods, enrobed foods, and other dough-containing food products, as well as meal dishes. These food products may include, for example, sandwiches (e.g., sandwich foods constructed with sliced bread, wraps, buns, or rolls, etc. and at least one edible filling such as meat, vegetable and/or dressing), gyros, burritos, egg rolls, pizzas, calzones, soy burgers, hot dogs, tacos, fajitas, nachos, meat pies, dumplings, pastries, pastry pies, meal dishes, and so forth.

### BRIEF DESCRIPTION OF THE DRAWINGS

FIG. 1 is a right front perspective view of an apparatus for providing food self-service according to an embodiment of the invention.

FIG. 2 is a front elevational view of the apparatus of FIG. 1.

FIG. 3 is a front top exploded view of the apparatus of FIG. 1.

FIG. 4 is a front bottom exploded view of the apparatus of FIG. 1

FIG. 5 is an enlarged view of encircled area 500 in FIG. 3.

FIG. 6 is a right side sectional view of the apparatus of FIG. 1.

FIG. 7 is a front elevational view of an alternative configuration of an apparatus for providing food self-service according to another embodiment of the invention.

FIG. 8 is a right front perspective view of an alternative configuration of an apparatus for providing food self-service according to another embodiment of the invention.

FIG. 9 is a front elevational view of the apparatus of FIG. 8.

FIG. 10 is a right front perspective view of an alternative configuration of an apparatus for providing food self-service according to another embodiment of the invention.

FIG. 11 is a front elevational view of the apparatus of FIG. 10.

FIG. 12 is a rear elevational view of the apparatus of FIG. 10.

FIG. 13 is a right side elevational view of the apparatus of FIG. 10.

FIG. 14 is a flow chart for a method using the apparatus of any one of FIG. 1, FIG. 7, FIG. 8, or FIG. 10 to provide self-service of food products according to another embodiment of the present invention.

The figures are not necessarily drawn to scale. Similarly numbered elements in different figures represent like features unless indicated otherwise.

### DETAILED DESCRIPTION OF PREFERRED EMBODIMENTS

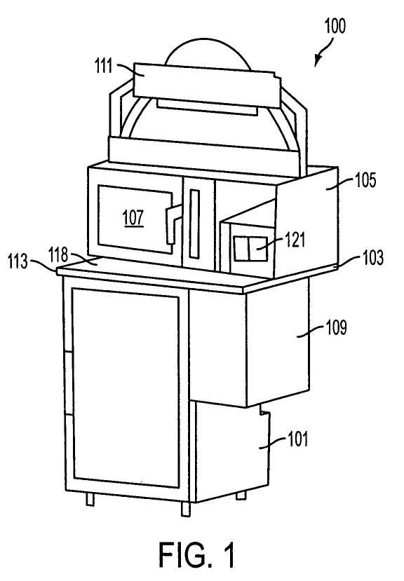

Referring to FIG. 1, an apparatus 100 for providing self-service of food is illustrated. The food service apparatus 100 is provided as an integral modular assembly comprising a food storage unit 101, countertop 103, cabinet module 105 housing an oven 107, and trash collection module 109, and a food advertising display module 111. Additional food service items 121, such as napkins, food trays, eating utensils, food condiments (e.g., packets or packages of food dressings, sauces, seasonings, etc.), and so forth, also may be stored in the cabinet module 105, such as placed in an enclosure space 108 thereof. In this illustration, the countertop 103 includes a portion 113 providing an exposed table surface area 118 in the assembled apparatus 100. Also, the oven 107, which is removably housed in enclosure space 106, is illustrated as having an electronic menu 170 including a plurality of cooking control buttons 171 and 172. The apparatus 100 is a combination providing everything needed for food storage, advertising, food preparation, and self-service.

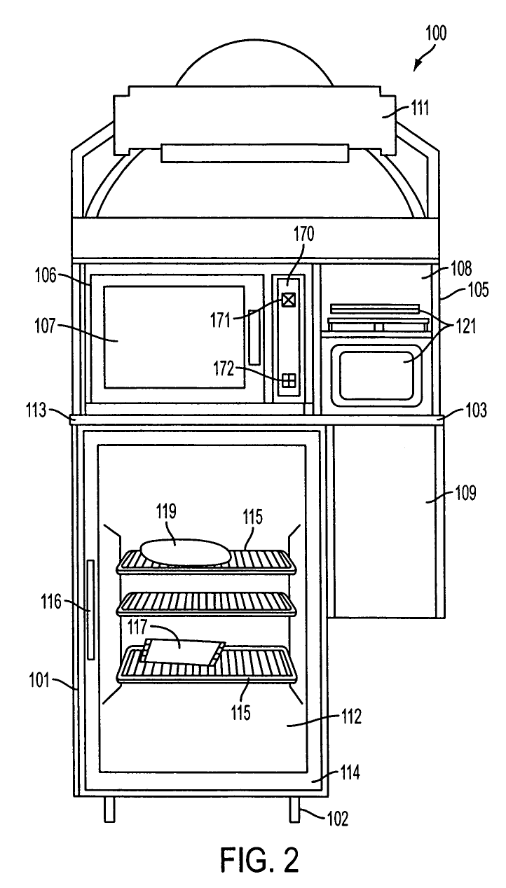

Referring to FIG. 2, the food storage unit 101 may be a freezer or refrigerator, which may be powered via a standard power cord connected to an electrical power source via an electrical power outlet provided in the retail store or other installation location (not shown). The food storage unit 101 of apparatus 100 contains racks 115 for storage of a plurality of packaged food items 117 (e.g., a burrito) and 119 (e.g., a pizza) under chilled conditions. It will be appreciated that other types and amounts of packaged foods can be stored in the food storage unit 101, if space permits. The food items that can be merchandised with the apparatus are not particularly limited. In a particular embodiment, they are packaged food products including, for example, sandwiches, food wraps, pocket-type foods, enrobed foods, and other dough-containing food products, as well as meal dishes or other portable foods. These food products may include, for example, sandwiches (e.g., sandwich foods constructed with sliced bread, wraps, buns, or rolls, etc. and at least one edible filling such as meat, vegetable and/or dressing), gyros, burritos, egg rolls, pizzas, calzones, soy burgers, hot dogs, tacos, fajitas, nachos, meat pies, dumplings, pastries, pastry pies, meal dishes, and so forth.

The food storage unit 101 has a transparent portion 112 on its front door 114 which has a handle 116 provided to aid opening and closing the door. The transparent portion 112 (e.g., a glass or plastic window) permits patrons to view the types and amounts of food items available in the food storage unit 101 for selection without needing to open the storage unit door 114. The racks 115 may be expandible/contractible to fit around a food product. The food products also may be stored in feeder racks of a conventional type used in retail freezers or refrigerators (not shown). A space also may be provided within the food storage unit to hold an extra supply of food products available to be placed into feeder racks if they become empty. The food storage unit also may have an internal light source, e.g., a light bulb, which stays illuminated even when the access door of the food storage unit is closed. The food storage unit also may have a pre-programmed or manually activatable defrost cycle to keep the window free from condensation. All components in the food storage unit can be configured to be easily adjusted to accommodate additional food products. The food storage unit 101 is illustrated as having bottom support legs 102. The supports 102 also may comprise wheels, e.g., caster wheels, which may be operable to be releasably locked into fixed position.

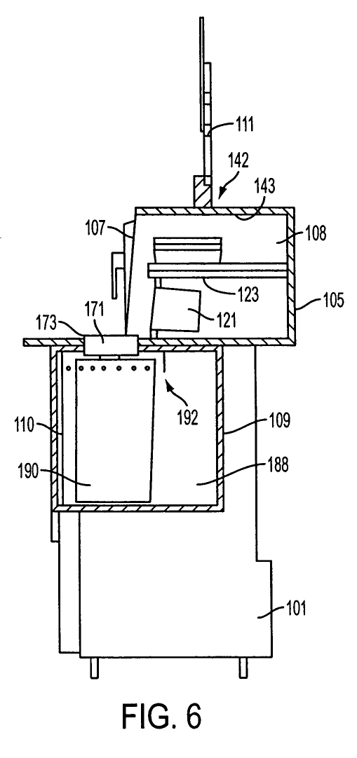

As indicated, the countertop 103 includes a portion 113 thereof which protrudes and extends laterally away from other modules of the apparatus 100 (including at least the cabinet module 105 and oven 107 housed therein), providing an exposed generally horizontal table surface area 118 upon which a customer can handle and prepare a food selection, and/or set other belongings down while preparing a food selection. The countertop 103 also may include portions which overhang food storage unit 101 and trash collection module 109 (e.g., see FIG. 6).

The countertop 103 may be constructed of a rigid unitary board, slab, panel or laminate construction, e.g., wood, particle board, oriented strand board, veneer laminate, polymer, fiber-reinforced polymer, etc. As will be appreciated, composite and laminate panels may be molded to a desirable shape during manufacture.

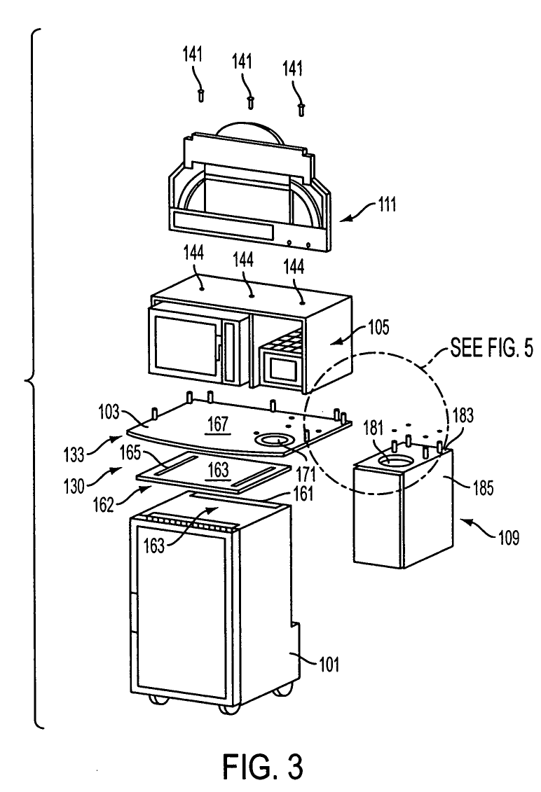

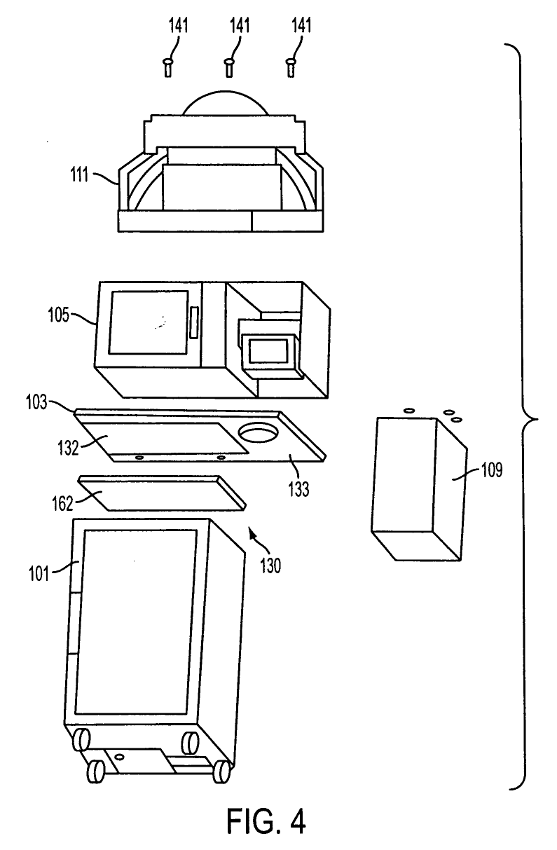

The cabinet module 105 is attached to the countertop 103, and defines enclosure space 106 in which the oven 107 is housed. In this illustration, the oven 107 is surrounded by cabinetry except on the front side, allowing the customer access to an oven door and operational buttons. That is, the cabinet module 105 includes right and left sidewalls, a rear wall, a top side, and a bottom side integrally connected together (e.g., also see FIGS. 3-4). Oven 107 is operable to rapidly cook a food item (e.g., within about 15 minutes), is removably placed in the enclosure space 106. The oven 107 may be a microwave oven, convection oven, a hybrid oven combining microwave and convection heating means, a toaster, and so forth. The oven 107 may be powered via a standard power cord, such as one run through an opening providing in a rear wall of the cabinet module 105 to an electrical power source via an electrical power outlet provided in the retail store or other installation location (not shown).

As indicated, the oven 107 may comprise an electronic menu 170 including a plurality of buttons 171 and 172 each pre-programmed to activate the oven 107 to heat a corresponding food item from the storage unit for a predetermined set of heating conditions (e.g., heating time, power, etc.) for a given food item. The oven 107 may include a programmable or preprogrammed electronic cooking controller, and visual identifying means provided on the electronic menu 170 next to each of the plurality of push control buttons 171 and 172 identifying one of the plurality of different types of food items stored in the food storage unit. The buttons 171 and 172 are manually activatable to activate the controller to operate the oven to heat a selected type of frozen food item under predetermined cooking conditions corresponding to the selected type of frozen food item. Thus, different kinds and/or shapes of food products can be cooked with the same oven aboard the apparatus. It will be appreciated that a lesser or greater number of such push button controls may be provided.

The cabinet module 105 may further define an additional enclosure space 108 adjacent the oven 107, which is adapted to receive and store at least one food service item selected from the group consisting of napkins, eating utensils, food trays (e.g., finished product boxes which customers can use for take-out of cooked food products), and food condiments. In this non-limiting illustration, a vertical divider wall 174 in the cabinet module 105 separates enclosure spaces 106 and 108. In this non-limiting illustration, the enclosure space 108 is subdivided into two vertically aligned subcompartments separated by a horizontal divider 175, and the lower subcompartment thereof may have a framed front face 176 defining an opening into the subcompartment as illustrated. There also may be additional space provided on top of the cabinet module 105 allowing a customer to set things down while preparing a food product. Instructions on operation of the oven can also be displayed there.

The cabinet module 105 may be an enclosure constructed from rigid boards or panels cut or manufactured to appropriate sizes suitable to be assembled into an integral enclosure configuration. The board or panel material may be, e.g., wood, particle board, veneer laminate, oriented strand board, polymer, fiber-reinforced polymer, etc. It also may manufactured as a single molded piece, e.g., a molded polymer or fiber-reinforced polymer material, etc.

The food-advertising display module 111 is attached to the cabinet module 105 of the food kiosk assembly 100. The display module 111 may comprise signage including graphics identifying at least one food item contained in the food storage unit 101. For example, a menu board also may be displayed on the display module 111. The graphics displayed on the display module 111 may identify a food type, food brand, display a menu board, and/or other advertising (e.g., meal deals, specials, other offers).

The display module 111 may be constructed of rigid or semi-rigid components, e.g., metal, wood, particle board, oriented strand board, veneer laminate, polymer, fiber-reinforced polymer, paperboard, etc., or combinations thereof. For instance, the display module may comprise an aluminum grid bearing advertising graphics integrally connected to a mounting block at its base for attachment to the cabinet module 105.

The apparatus 100 may further include a trash collection module 109 attached to the cabinet module 105. The trash collection module 105 may have a cabinet construction including sidewalls and an upper surface which may be made of a rigid board, panel, or laminate material, e.g., wood, particle board, oriented strand board, polymer, fiber-reinforced polymer, etc. The trash collection module 109 also has other features such as described in more detail below with reference to FIGS. 3-6.

Referring to FIG. 3, the apparatus 100 may be provided as an assembly of separably connected modules including at least the above-indicated components. The display module 111 may be separably connected to the cabinet module 105, such as, for example, by using thumbscrews 141 which inserted through a flanged portion 142 of the display module and connected to an upper surface 143 of the cabinet module 105 via guide holes 144 provided therein (also see FIG. 6). The countertop 103 has a throughhole 171 which aligns with a throughhole 181 provided in the trash collection module 109 when the apparatus 100 is assembled together.

To facilitate the assembly of the modules, a mounting block 130 is attached between the food storage unit 101 and the countertop 103. The mounting block 130 may be adhesively and mechanically interconnected between the food storage unit 101 and countertop 103. In this non-limiting illustration, several strips of double-sided adhesive tape 161 are applied to the top surface 163 of the food storage unit 101. The bottom surface 162 of the mounting block 130 is pressed onto the adhesive tape 161 and top surface 163 of the food storage unit 101. Several strips of double-sided adhesive tape 165 are applied to top surface 163 the mounting block 130, which is pressed onto the lower surface 133 of the countertop 103. As will be appreciated, the double-sided adhesive tape 161 alternatively or additionally can be applied to the bottom surface 162 of the mounting block 130, and the double-sided adhesive tape 165 alternatively or additionally can be applied to the lower surface 133 of the countertop 103. The double-side adhesive tape 161 and 165 may be, for example, 2400 series tape, 3M Company, St. Paul, Minn.

Referring to FIG. 4, the countertop 103 also includes a recessed or relief region 132 in the bottom surface 133 thereof having a shape adapted to conformably receive and mechanically interfit the mounting block 130 therein.

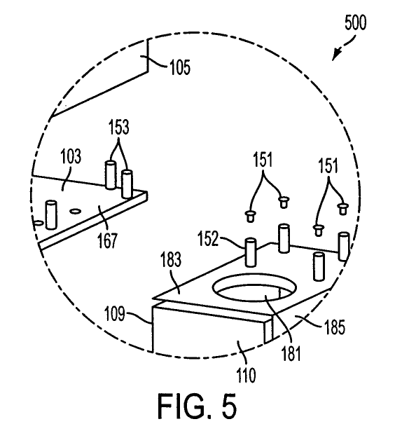

Referring to FIG. 5, the cabinet module 105 may be attached to the upper surface 167 of the countertop 103, such by use of wood screws 153. The trash collection module 109 is separably connected to countertop 103, such as by use of prop nuts 151 and pan heads 152. The trash collection module 109 includes a top side 183 defining throughhole 181, sidewalls 185, and a side door 110.

Referring to FIG. 6, a flanged rubber or plastic sleeve 173 having a downward extending portion may be fitted to throughhole 171 in the countertop 103 to extend through throughhole 181 of the trash collection module 109 and into an interior cavity 188 defined by the sidewalls 185 and top side 183 of the trash cabinet 109. This feature can help to direct trash into a trash receptacle 190 removably stored within the trash collection module 109. Patrons may conveniently and cleanly deposit trash into the trash receptacle 190 via countertop throughhole 171 and throughole 181 of the trash collection module 109. The trash receptacle 190 is readily accessible from the front of the apparatus 100 via a hinged side door 110. This allows for easy clean up and disposal of waste. The trash receptacle 190 may be an open-mouthed elongate container.

The trash receptacle 190 may have a pull-out configuration with the trash collection module 109. For example, the trash receptacle 190 may have a flanged or collared mouth adapted to allow it to be slidably mounted and maneuvered in and/or out of the cavity 188 on guide rails 192 or similar means provided on inner surfaces of the top side 183 and/or sidewalls 185 of trash collection module 109. The guide rails 192 may include or be associated with a backstop which delimits movement of the trash receptacle 190 into cavity 188 at a location directly beneath the throughholes 181 and 171 in a generally aligned orientation of these features.

The food service item 121 may be napkins dispensed from a napkin dispenser 123, such as a standard device which feeds napkins out via a spring loaded paddle. Food trays and/or food condiments may be stacked on top of the napkin dispenser 123.

Although the apparatus 100 in FIGS. 1-6 is exemplified in a configuration in which the cabinet module 105 enclosing the oven 107 is vertically stacked over the food storage unit 101 with the intervening countertop 103, it will be appreciated that other configurations of the various modules may be provided. For instance, the food storage unit may be positioned vertically above the oven with the intervening countertop.

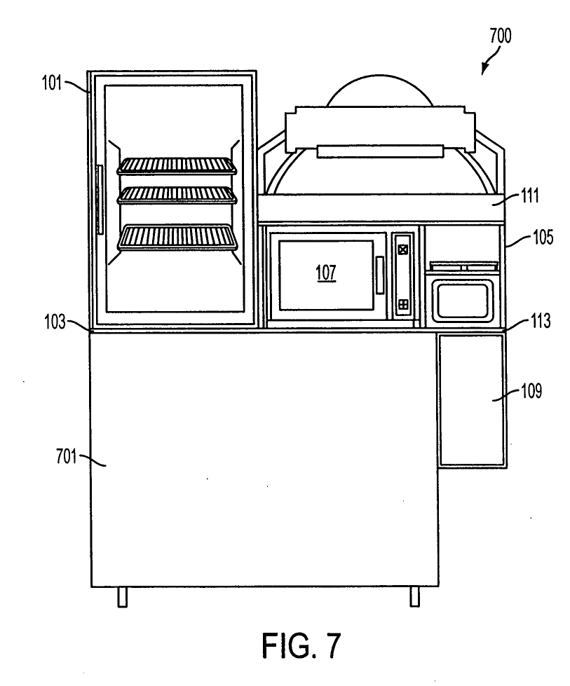

With reference to FIG. 7, the food self-service apparatus 700 also may be configured such that the cabinet module 105 enclosing the oven 107, and the food storage unit 101, are positioned laterally side-by-side above a common platform 701, and the countertop 103 can be attached between a top surface of the platform 701 and lower surface(s) of one or both of the food storage unit 101 and cabinet module 105 enclosing the oven 107.

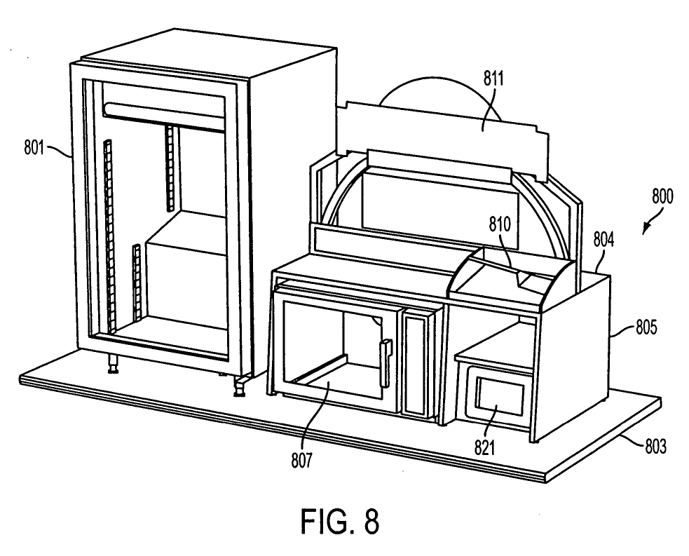

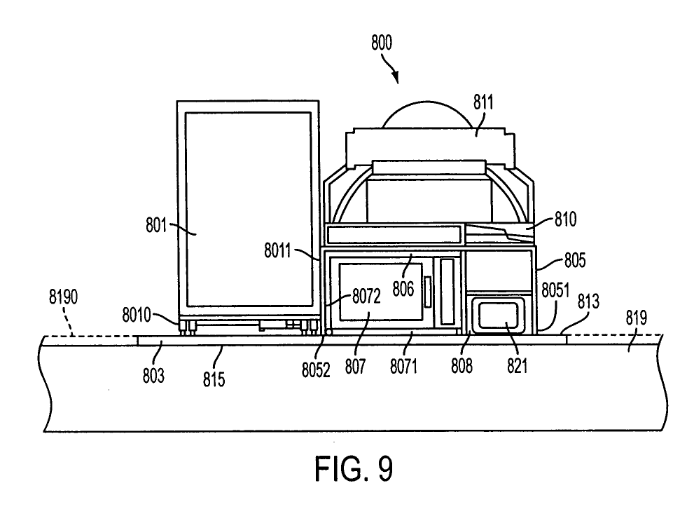

With reference to FIGS. 8-9, in another embodiment of the invention the above-discussed trash collection module and receptacle is omitted from the food service apparatus. As shown, a food service apparatus 800 is provided as an integral modular assembly comprising a food storage unit 801 and a cabinet module 805 housing an oven 807, resting in side-by-side configuration on rigid support member 803 as the countertop means. The rigid member 803 may be a discrete member or form part of a larger surface area of a countertop or the like. In one implementation, the lower ends 8051, 8052 of the cabinet module 805, bottom surface 8071 of oven 807, and legs 8010 of the food storage unit 801 rest upon the top surface 813 of a discrete slab member 803, or a surface portion 8190 of a large surface area countertop 819, but need not be attached thereto mechanically or adhesively. In another embodiment, the lowermost exposed surfaces of one or more of the cabinet module, oven and/or freezer or legs thereof may be attached to the countertop surface in a manner that aids in preventing undesired lateral displacement of the module components. The attachment may be mechanical (e.g., screws, bolts), adhesive (e.g., double-faced adhesive tape), or a combination of both. The adjoining vertical, facing sides 8011 and 8072 of the food storage unit 801 and cabinet module 807, respectively, may be fixed in position in the assembled module in physical contact or alternatively may be positioned in close proximity but out of contact. A food advertising display module 811 also is provided which is attached to the top surface 804 of the cabinet module 805 using common structural mechanical and/or adhesive attachment means, such as those previously described herein.

Additional food service items 821, such as napkins, food trays, eating utensils, food condiments (e.g., packets or packages of food dressings, sauces, seasonings, etc.), and so forth, also may be stored in the cabinet module 805, such as placed in an enclosure space 808 thereof, and/or in a tray 810 provided above such space. In this non-limiting illustration, the support slab member 803 includes an upper surface 813 providing an exposed table surface area upon which in the food storage unit 801 and the cabinet module 805 housing the oven 807 are positioned. In one embodiment, the lower surface portion 815 of the slab member 803 can be positioned upon a separate relatively large surface area kitchen-type countertop 819, such as one provided in a convenience store or other food service establishment in which the food preparation apparatus is located. Alternatively, member 803 can represent an integral portion of larger surface area 8190 (indicated by hatched lines) of a large countertop 819. The cabinet module 805 is a hutch-like construction including internal enclosure spaces defined by divider walls. The cabinet module 805 can be assembled separately before incorporation into apparatus 800, such as using conventional means applied to assemble such structures. Reference is made to cabinet module assembly methods illustrated above in this regard. The oven 807 is removably housed in an enclosure space 806 provided in cabinet module 805. The food storage unit 801 and oven 807 can comprise types such as those previously described herein. The apparatus 800 also is a combination providing everything needed for food storage, advertising, food preparation, and self-service.

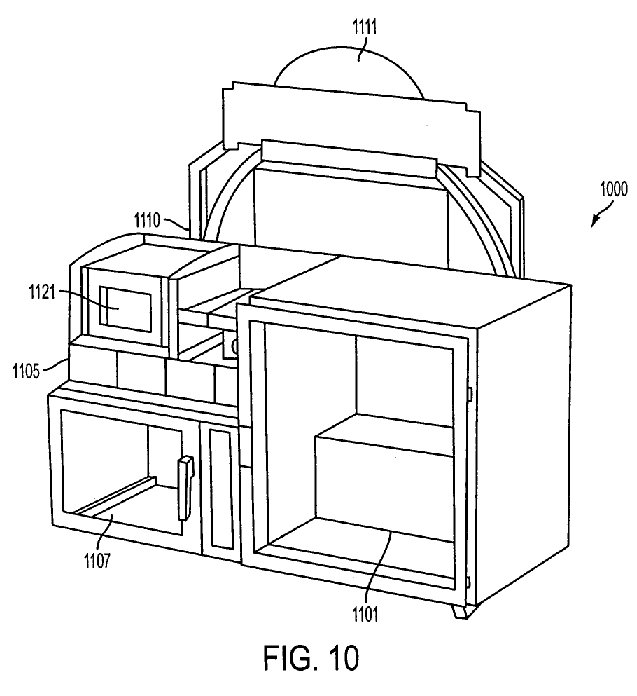

With reference to FIGS. 10-13, a food service apparatus 1000 is provided comprising a food storage unit 1101 and a cabinet module 1105 housing an oven 1107. The food storage unit 1101 and the cabinet module 1105 are arranged side-by-side, i.e., laterally adjacent to one another in a generally horizontal direction x.

A food-advertising display module 1111 included generally has an integral “L”-shape including a relatively longer substantially upright portion 1111a and a relatively shorter substantially horizontal portion 1111b (see FIG. 13). In one embodiment, the food-advertising display module 1111 is not fixedly attached to the food storage unit 1101 and/or cabinet module 1105. Instead, a lower portion of the food storage unit 1101, viz. its rear legs 1101a (one shown in FIG. 13, the other is similarly arranged near the rear end of the food storage unit) or the rear bottom side 1101b itself thereof if there are no legs of the food storage unit, and, separately, a bottom portion 1107a of the oven 1107 (e.g., a rearward exposed bottom surface thereof) rest upon the lower horizontal portion 1111b of food-advertising display module 1111. This arrangement is effective to stabilize the display module 1111 against tilting or tipping, e.g., if it is inadvertently bumped or leaned upon. The bottom portion 1111b of the display module 1111 should have a length “y” sufficient to extend under any legs of the food storage unit and pass under enough of the oven and/or food storage unit to stabilize the upright portion 1111a of the display module 1111.

The L-shaped display module 1111 can be assembled from multiple parts into a single-piece unitary L-shape, or it may be molded or machined from a suitable material (e.g., plastic, wood, metal) directly into that configuration. The L-shaped display module 1111 particularly may comprise a laminated construction. The signage or other components of the display module 1111 may be assembled into a single-piece construction with any convenient suitable means, such as mechanical or adhesive connection means (e.g., screws, bolts and nuts, nails, adhesive, or combinations thereof), including, e.g., those previously described herein. These components preferably are tightly fastened together sufficient that none of the display module pieces can independently move in position relative to the other components thereof, such as by swinging, pivoting, rotating, projecting, receding, etc.

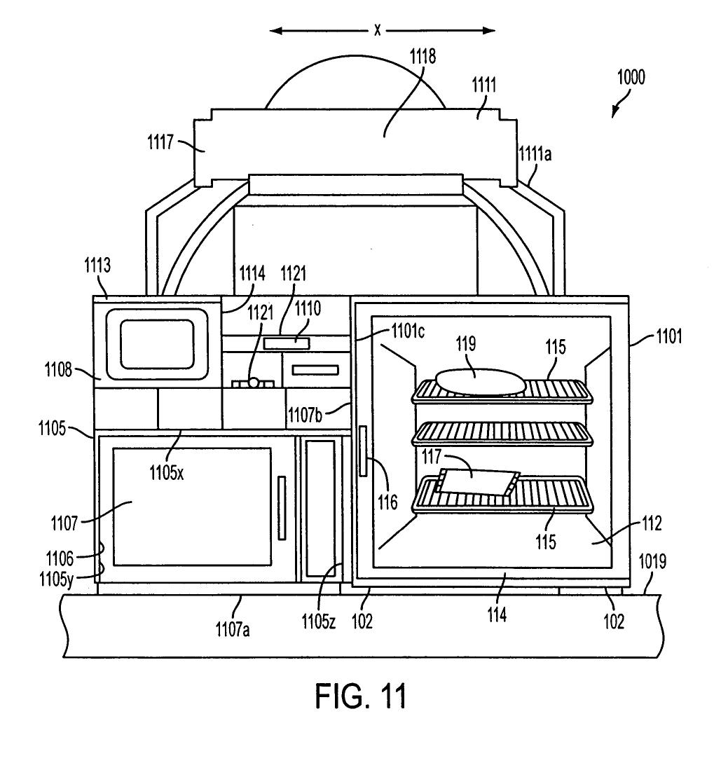

The resulting food service assembly 1000 is adapted to be supported as a combined system on a separate relatively large surface area kitchen-type countertop 1019, such as one provided in a convenience store or other food service establishment in which the food preparation apparatus is located. The lower surface 1107a of the oven 1107 and the legs 102 (1101a) of the food storage unit 1101 can be positioned upon a separate relatively large surface area kitchen-type countertop 1019, such as one provided in a convenience store or other food service establishment in which the food preparation apparatus is located (see FIG. 11).

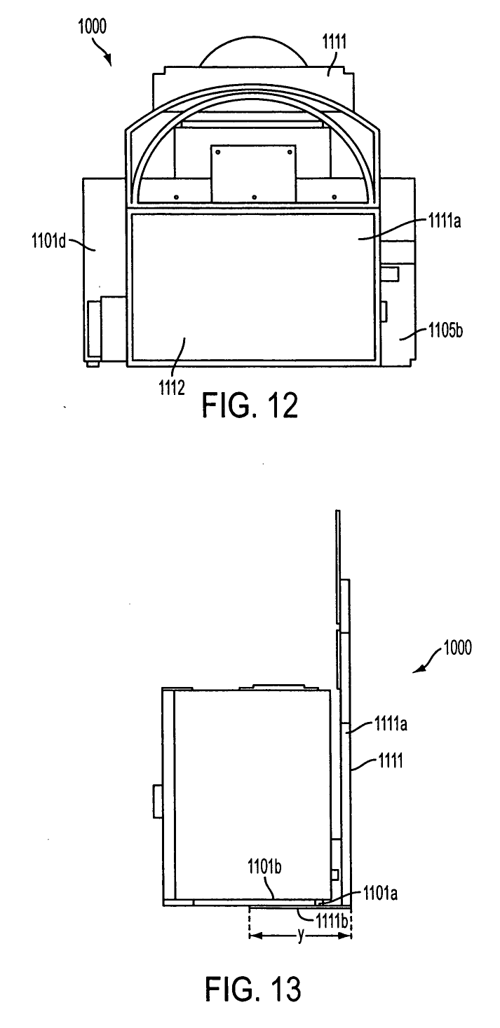

Referring still to FIGS. 10-13, the food storage unit (1101), cabinet module (1105), oven (1107) and advertising display module (1111) components of this embodiment of the apparatus may have similar features, constructions and functions such as described forth these various components in the above descriptions of FIGS. 1-9, and reference is made thereto, with the following qualifications. For instance, the cabinet module 1105 is a hutch-like construction including internal enclosure spaces 1106 and 1108 defined by divider walls 1113, 1114, etc. In this embodiment, cabinet module 1105 is open at its lower side, i.e., it has no bottom enclosing side. In a particular embodiment, it comprises a three-sided enclosure including an upper horizontal-extending portion 1105x and lateral vertical-extending sides 1105y and 1105z, which respectively enclose the upper side and lateral sides of the oven 1107 (e.g., see FIG.). Optionally, inner lateral side 1105z could be omitted from cabinet module 1105. The bottom side 1107a of the oven 1107 directly comes into contact with the countertop 1019 and/or bottom portion 1111b of the display module 1111, as applicable. The cabinet module 1105 can be assembled separately before incorporation into apparatus 1000, such as using conventional means applied to assemble such structures. Reference is made to cabinet module assembly methods illustrated above in this regard. The oven 1107 is removably housed in an enclosure space 1106 provided in cabinet module 1105. Also, the adjoining vertical, facing sides 1101c and 1107b of the food storage unit 1101 and cabinet module 1107, respectively, may be fixed in position in the assembled module in physical contact or alternatively may be positioned in close proximity but out of contact. If put into contact, mechanical and/or adhesive attachment means may be used to further immobilize the assembly, although not required. Referring to FIG. 12 in particular, the upright portion 1111a of food advertising display module 1111 includes a generally planar lower portion 1112 adjacent to the rear surface 1101d of the food storage unit 1101 and a rear surface 1105b of the cabinet module 1105. The rear surface 1105b may be used to provide a rear surface for the oven enclosure 1106 defined by the cabinet module. The upright portion 1111a of the food-advertising display module 1111 may comprises signage 1117 including graphics 1118 (which may be pictorial and/or textual, etc.) identifying at least one food item contained in the food storage unit (e.g., see FIG. 11).

Although not required, the food display unit 1111 could additionally be attached to either the adjacent surfaces of the food storage unit and/or cabinet module attachments may be made using conventional structural mechanical and/or adhesive attachment means suitable for making these types of attachments, such as those previously described herein.

As shown in more detail in FIGS. 10-11, additional food service items 1121, such as napkins, food trays, eating utensils, food condiments (e.g., packets or packages of food dressings, sauces, seasonings, etc.), and so forth, also may be stored in the cabinet module 1105, such as placed in an enclosure space 1108 thereof, and/or in a tray 1110 provided above such space.

The food storage unit 1101 is similar to previously described food storage unit 101 as it may be a freezer or refrigerator, which may be powered via a standard power cord connected to an electrical power source via an electrical power outlet provided in the retail store or other installation location (not shown). The food storage unit 1101 of apparatus 1000 also may contain racks 115 or other shelving for storage of a plurality of packaged food items 117 (e.g., a burrito) and 119 (e.g., a pizza) under chilled conditions. It will be appreciated that other types and amounts of packaged foods can be stored in the food storage unit 1101, if space permits. The food items that can be merchandised with the apparatus 1000 are not particularly limited. The food storage unit 1101 also has a transparent portion 112 on its front door 114 which has a handle 116 provided to aid opening and closing the door. The transparent portion 112 (e.g., a glass or plastic window), as explained above, permits patrons to view the types and amounts of food items available in the food storage unit 1101 for selection without needing to open the storage unit door 114. The oven 1107 is similar to oven 107 described above. It may be a microwave oven, convection oven, a hybrid oven combining microwave and convection heating means, a toaster, and so forth. The oven 1107 may be powered via a standard power cord to an electrical power source via an electrical power outlet provided in the retail store or other installation location (not shown). As can be appreciated, the apparatus 1000 is a combination providing everything needed for food storage, advertising, food preparation, and self-service.

In the food preparation apparatus of FIG. 1, 7, 8, or 10, the microwave oven or other oven effectively is positioned upon a platform that is used to elevate the oven equipment off the floor, allowing for improved air circulation and improved cooking. This helps to ensure that food can be cooked to reach a high temperature in the oven in a short period time, e.g., within minutes. The apparatus alternatively can be designed to sit on the floor or a countertop and provide all needed food service items (napkins, garbage can, etc).

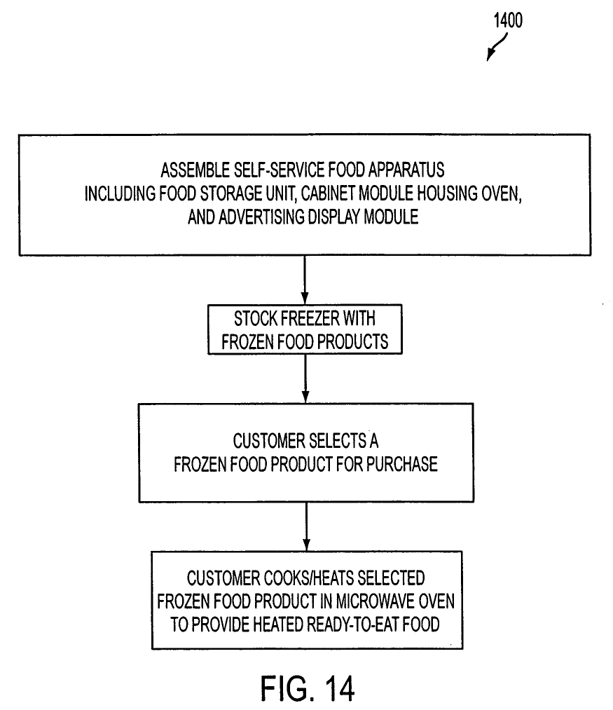

Referring to FIG. 14, there is a method 1400 for providing food service, comprising (A) locating, at a desired food retail location, an apparatus 100, 700, 800, or 1000, such as described herein, in which the apparatus is shipped as an unassembled kit that is assembled on site, or pre-assembled to the extent applicable and shipped; and (B) placing a plurality of food items in the food storage unit of the apparatus which are available for selection and rapid preparation by patrons in the oven component of the apparatus and handling on the exposed preparation surface forming part of the countertop of the apparatus.

The food apparatus of embodiments of the present invention is a stand-alone food delivery system which may be used in convenience retail stores and other venues suited for walk-up and walk-out/walk-away food service by patrons of the self-service units. Patrons can select a food product of their choice from food storage equipment, prepare and cook it themselves in the cooking device, and obtain food service items from the apparatus as needed or desired by themselves. The apparatus provides all needed items for patrons or customers to prepare and cook their own food in one convenient location. The apparatus is a modular assembly which can be pre-assembled and shipped as an integral unit to a retail location, or moved from one retail location to another as a single unit, or alternatively it may be shipped as individual modules for easy assembly on site. In addition to the components described above, the apparatus may also have other appendages that can hold merchandising, advertising, and menu boards that can be interchanged or customized to the establishments offering.

While the invention has been particularly described with specific reference to particular process and product embodiments, it will be appreciated that various alterations, modifications and adaptations may be based on the present disclosure, and are intended to be within the spirit and scope of the present invention as defined by the following claims.

What is claimed is:

1. A food service apparatus, comprising:
a food storage unit adapted to contain a plurality of packaged food items under chilled conditions;
a cabinet module defining an enclosure space;
an oven is removably placed within the enclosure space wherein said cabinet module encloses the oven on its upper side and at least one lateral side, and wherein said oven is operable to cook a food item, and wherein the food storage unit and cabinet module are arranged side-by-side;
a food-advertising display module including a substantially upright portion and a substantially horizontal portion upon which a lower portion of the food storage unit and a bottom portion of the oven rests, effective to stabilize the display module.

2. The apparatus of claim 1, wherein the upright portion of the food-advertising display module comprises signage including graphics identifying at least one food item contained in the food storage unit.

3. The apparatus of claim 1, wherein the food storage unit includes an access door having a transparent portion adapted to allow food items stored within the food storage unit to be viewed from outside the food storage unit.

4. The apparatus of claim 1, wherein the food storage unit comprises a freezer.

5. The apparatus of claim 1, wherein the oven comprises a microwave oven.

6. The apparatus of claim 1, wherein the oven comprises an electronic menu including at least one button pre-programmed to activate the oven to heat a corresponding food item from the storage unit for a predetermined set of heating conditions for that food item.

7. The apparatus of claim 1, wherein the oven comprises a programmable cooking controller and a plurality of push control buttons associated with identifying means for a plurality of different types of food items stored in the storage unit, wherein the buttons are manually activatable to activate the controller to operate the oven to heat a selected type of frozen food item under predetermined cooking conditions corresponding to the selected type of frozen food item.

8. The apparatus of claim 1, wherein the cabinet module has no bottom enclosing side.

9. The apparatus of claim 1, wherein the cabinet module further defines an additional enclosure space, above the enclosure space housing the oven, adapted to receive and store at least one food service item selected from the group consisting of napkins, trays, eating utensils, and food condiments.

10. The apparatus of claim 1, wherein the oven further comprises an electrical power outlet adapted for connection of electrical power transmission means thereto.

11. The apparatus of claim 1, wherein the food storage unit further comprises an electrical power outlet adapted for connection of electrical power transmission means thereto.

12. The apparatus of claim 1, wherein a food-advertising display module generally has an integral L-shape.

13. A food service apparatus, comprising:
a food storage unit adapted to contain a plurality of packaged food items under chilled conditions;
a cabinet module defining at least one enclosure space, and arranged side-by-side with the food storage unit;
an oven, operable to cook a food item, removably placed in the at least one enclosure space;
a food advertising module attached to at least the cabinet module; and
a countertop upon which the food storage unit and the cabinet module are positioned in a side-by-side configuration.

14. A method for providing food service, comprising:
(A) locating, at a desired food retail location, an integral food service apparatus comprising:
a food storage unit adapted to contain a plurality of packaged food items under chilled conditions;
a cabinet module defining an enclosure space;
an oven is removably placed within the enclosure space wherein said cabinet module encloses the oven on its upper and lateral sides, and wherein said oven is operable to cook a food item, and wherein the food storage unit and cabinet module are arranged side-by-side;
a food-advertising display module including a substantially upright portion and a horizontal portion upon which a lower portion of the food storage unit and a bottom portion of the oven rests, effective to stabilize the display module; and
(B) placing a plurality of food items in the food storage unit.

15. The method of claim 14, further comprising storing in the food storage unit at least one of the plurality of food items advertised on the food-advertising display module.

16. The method of claim 15, further comprising cooking at least one of the food items in the oven.

17. The method of claim 16, wherein the oven is provided to further include an electronic menu including at least one button pre-programmed to activate the oven to heat a corresponding food item from the storage unit for a predetermined set of heating conditions for that food item.

18. The method of claim 14, wherein the oven comprises a programmable cooking controller and a plurality of push control buttons associated with identifying means for a plurality of different types of food items stored in the storage unit, wherein the buttons are manually activatable to activate the controller to operate the oven to heat a selected type of frozen food item under predetermined cooking conditions corresponding to the selected type of frozen food item.

19. The method of claim 14, wherein the cabinet module further defining an additional enclosure space and/or storage tray adapted to receive and store at least one food service item selected from the group consisting of napkins, trays, eating utensils, and food condiments.
